(19) United States
(12) Patent Application Publication
(10) Pub. No.: US 2018/0196621 A1
(43) Pub. Date: Jul. 12, 2018

(54) MEMORY MODULE, MEMORY SYSTEM AND OPERATING METHOD OF MEMORY SYSTEM

(71) Applicant: SK hynix Inc., Gyeonggi-do (KR)

(72) Inventor: Ja-Hyun KOO, Gyeonggi-do (KR)

(21) Appl. No.: 15/670,123

(22) Filed: Aug. 7, 2017

(30) Foreign Application Priority Data
Jan. 10, 2017 (KR) 10-2017-0003439

(51) Int. Cl. G06F 3/06; G06F 12/10

(52) U.S. Cl. CPC G06F 3/0659; G06F 3/0608; G06F 12/10; G06F 3/0683; G06F 3/0638

(57) ABSTRACT

An operating method of memory system may include: transmitting a write command from a memory controller to a memory module; transmitting write data corresponding to the write command from the memory controller to the memory module; generating compressed data by compressing the write data in the memory module; writing the compressed data to one or more memory devices in the memory module; and transmitting unused r Memory capacity information on the memory module to the memory controller from the memory module.

### CROSS-REFERENCE TO RELATED APPLICATION

This application claims priority under 35 U.S.C. §119 to Korean Patent Application No, 10-2017-0003439, filed on Jan. 10, 2017, in the Korean Intellectual Property Office, the disclosure of which is incorporated herein by reference in its entirety.

### TECHNICAL FIELD

Exemplary embodiments of the present disclosure relate to a memory module, a memory system employing the memory module and an operating method thereof.

### DISCUSSION OF THE RELATED ART

Recently, mobile communication terminals such as smartphones or tablet PCs have become very popular and the use of various networks such as a social network service (SNS), a machine to machine (M2M) network, a sensor network, etc. has increased dramatically. As a result, the amount of data, the generation speed of the data and the diversity of the data are increasing exponentially.

Although a memory speed is important for processing big data, a memory device and a storage capacity of a memory module including the same are required to be very large. Typically, only a rapid dynamic, random-access memory (DRAM) is included in a memory module used as a system memory, but as an increase in capacity is required, efforts to include a nonvolatile memory such as a NAND flash or a phase change random access memory (PCRAM) having a large capacity in a memory module have increased.

### SUMMARY

Various embodiments are directed to a technology for increasing an available memory capacity n a memory system.

In an embodiment, an operating method of a memory system, the operating method including: transmitting a write command from a memory controller to a memory module; transmitting write data corresponding to the write command from the memory controller to the memory module; generating compressed data by compressing the write data in the memory module; writing the compressed data to one or more memory devices in the memory module; and transmitting unused memory capacity information on the memory module to the memory controller from the memory module.

In an embodiment, the transmitting of the unused memory capacity information may be performed each time a write operation is completed.

In an embodiment, the transmitting of the unused memory capacity information may be periodically performed.

In an embodiment, the transmitting of the unused memory capacity information may be performed in response to a request from the memory controller.

In an embodiment, the operating method may further include: transmitting a read command from the memory controller to the memory module; reading read data from the memory devices; generating decompressed data by decompressing the read data in the memory module; and transmitting the decompressed data from the memory module to the memory controller.

In an embodiment, a memory module may include: one or more memory devices; a compress/decompress circuit suitable for compressing write data to the memory devices and decompressing read data read from the memory devices; and a capacity measuring circuit suitable for generating unused memory capacity information on the memory module.

In an embodiment, the memory module may transmit the unused memory capacity information to a memory controller each time a write operation is completed.

In an embodiment, the memory module may periodically transmit the unused memory capacity information to a memory controller

In an embodiment, the memory module may transmit the unused memory capacity information to a memory controller in response to a request from the memory controller.

In an embodiment, the memory module may further include an address mapping circuit suitable for mapping a logical address received from a memory controller to a physical address for selecting an area to be accessed in the memory devices.

In an embodiment, a memory system include: a memory module including one or more memory devices and a module controller suitable for controlling the memory devices; and a memory controller suitable for instructing an operation of the memory module, wherein the module controller includes: a compress/decompress circuit suitable for compressing write data to the memory devices and decompressing read data read from the memory devices; and a capacity measuring circuit suitable for generating unused memory capacity information on the memory module.

In an embodiment, the memory module may transmit the unused memory capacity information to the memory controller each time a write operation is completed.

In an embodiment, the memory module may periodically transmit the unused memory capacity information to the memory controller.

In an embodiment, the memory module may transmit the unused memory capacity information to the memory controller in response to a request from the memory controller.

In an embodiment, the module controller may further include an address mapping circuit suitable for mapping a logical address received from the memory controller to a physical address for selecting an area to be accessed in the memory devices.

### BRIEF DESCRIPTION OF THE DRAWINGS

FIG. 1 is a block diagram of a memory system in accordance with an embodiment of the present invention.

FIG. 2 is a flowchart illustrating a write operation of the memory system shown in FIG. 1.

FIG. 3 is a diagram for explaining a step shown in FIG. 2 performed in response to a request from a memory controller.

FIG. 4 is a flowchart illustrating a read operation of the memory system shown in FIG. 1.

### DETAILED DESCRIPTION

Various embodiments of the present invention will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

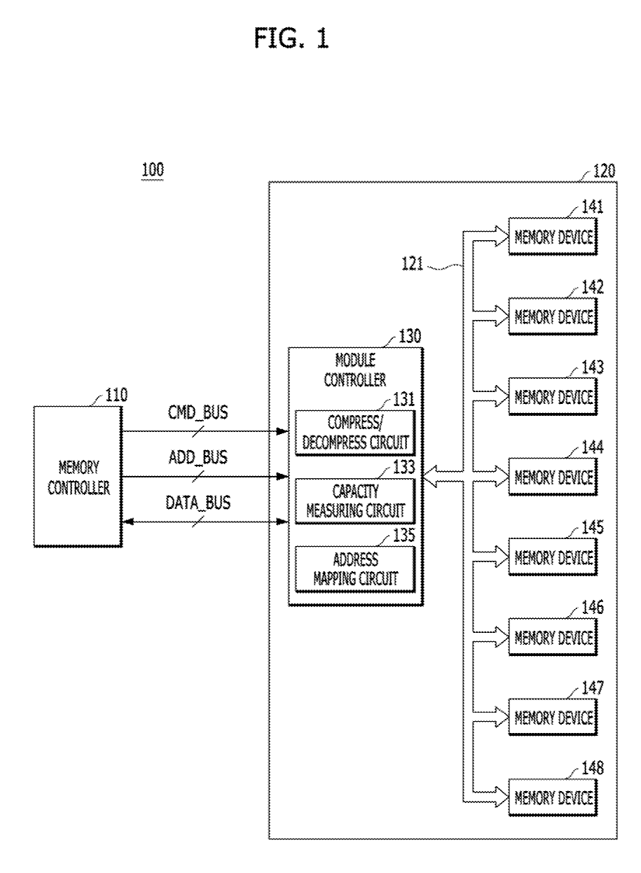

FIG. 1 is a block diagram of a memory system 100, in accordance with an embodiment of the present invention.

Referring to FIG. 1, the memory system 100 may include a memory controller 110 operatively coupled to a memory module 120.

The memory controller 110 may transmit a command to the memory module 120 through a command bus CMD_BUS, and a logical address to the memory module 120 through an address bus ADD_BUS. In addition, the memory controller 110 may transmit data to be written (hereinafter, referred to as “write data”) to the memory module 120 and receive data to be read (hereinafter, referred to as “read data”) from the memory module 120, through a data bus DATA_BUS. The memory controller 110 may instruct operations such as a write operation and a read operation for the memory module 120 by applying the command and the logical address to the memory module 120 transmit the write data to the memory module 120 during the write operation, and receive the read data from the memory module 120 during the read operation.

Each of the command bus CMD_BUS, the, address bus ADD_{——}BUS, and the data bus DATA_BUS may include a plurality of transmission lines.

The memory module 120 may include a module controller 130 and a plurality of memory devices 141 to 148. The plurality of memory devices 141 to 148 may be any one of various types of memory devices such as a DRAM, a PCRAM, and a NAND flash. The plurality of memory devices 141 to 148 may be the same type of memory devices or may include two or more different type memory devices. For example, the memory devices 141 to 146 may be DRAMs and the memory devices 147 and 148 may be PCRAMs. Here, although it is exemplified that the memory module 120 includes eight memory devices 141 to 148, the number of the memory devices included in the memory module 120 may be changed.

In operation, the module controller 130 may receive the command and the logical address from the memory controller 110 through the command bus CMD_BUS and the address bus ADD_BUS, and transmit/receive the write data and the read data to/from the memory controller 110 through the data bus DATA_BUS. Through an inner bus 121 in the memory module 120, the module controller 130 may transmit a command and a physical address to the memory devices 141 to 148, transmit write data to the memory devices 141 to 148 and receive read data from the memory devices 141 to 148, so as to control the memory devices 141 to 148 to perform operations such write and read operations. The module controller 130 may serve as an interface between the memory devices 141 to 148 and the memory controller 110.

The module controller 130 may include a compress/decompress circuit 131, a capacity measuring circuit 133 and an address mapping circuit 135.

The compress/decompress circuit 131 may compress write data designed to be written to the memory devices 141 to 148, in other words, the compress/decompress circuit 131 may compress the write data transmitted from the memory controller 110 and may transmit the compressed data to the memory devices 141 to 148. In addition, the compress/decompress circuit 131 may decompress the read data which are read from the memory devices 141 to 148 and may transmit decompressed data to the memory controller 110. A compression ratio of the compress/decompress circuit 131 may vary depending on a data pattern. For example, even when using an identical compression algorithm, 10 MB data may be compressed to 5 MB, or to 9 MB, depending on the pattern of data.

The capacity measuring unit 133 may generate unused memory capacity information UNUSED_INFO on a memory capacity or a memory size unused in the memory module 120. Since the memory module 120 may store the compressed data in which the compression ratio is not constant, the memory controller 110 may not determine a memory capacity available in the memory module 120. For example, when the entire capacity of the memory devices 141 to 148 in the memory module 120 is 512 gigabyte (GB), the memory controller may transmit write data of 400 GB to the memory module 120, the write data of 400 GB may be compressed to 200 GB, so that the memory module 120 may still have a memory capacity of 312 GB available. On the contrary, when the write data of 400 GB is compressed to c300 GB, the memory module 120 may only have a memory capacity of 212 GB further available. The unused memory capacity information UNUSED_INFO may enable the memory controller 110 to determine an unused memory capacity in the memory module 120. For example, the unused memory capacity information UNUSED_INFO may be information for indicating an unused memory capacity in the memory module 120 and for indicating a memory capacity already used in the memory module 120, Even if the unused memory capacity information UNUSED_INFO indicates the memory capacity already used in the memory module 120, the memory controller 110 may determine the memory capacity unused in the memory module 120.

The address mapping circuit 135 may map the logical address received from the memory controller 110 to the physical address for selecting and accessing an area in the memory devices 141 to 148. Since the write data transmitted from the memory controller 110 may not be written as it is, to the memory devices 141 to 148 in the memory module 120 but the compressed data corresponding to the write data is written thereto, the logical address may not be identical to the physical address. For example, when the memory controller 110 transmits the write data of 10 MB to the memory module 120, the compressed data of 5 MB may be written to the memory module 120. In this case, although the logical address transmitted to the memory module 120 from the memory controller 110 is for addressing an area corresponding to the write data of 10 MB, since the physical address for accessing the memory devices 141 to 148 in the memory module 120 is to address an area corresponding to the compressed data of 5 MB, the logical address is to be mapped to the physical address.

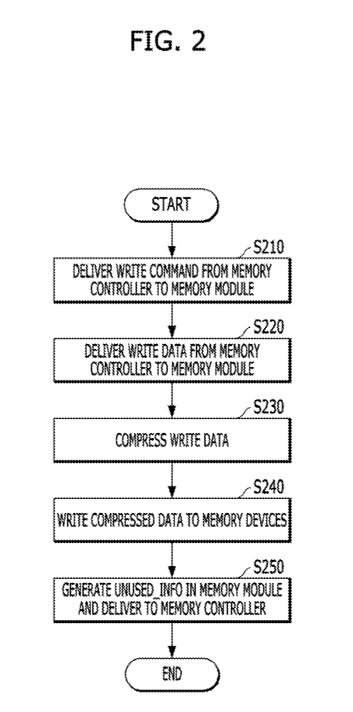

FIG. 2 is a flowchart illustrating a write operation of the memory system 100 of FIG. 1.

Referring to FIG. 2, a write command may be transmitted from the memory controller 110 to the memory module 120, at step S210. The write command may be transmitted through the command bus CMD_BUS. In addition, together with the write command, the logical its address may be transmitted from the memory controller 110 to the memory module 120 through the address bus ADD_BUS.

The write data corresponding to the write command having been transmitted at step S210 may be transmitted to the memory module 120 from the memory controller 110, at step S220. The write data may be transmitted through the data bus DATA_BUS.

At step S230, the compress/decompress circuit 131 of the module controller 130 in the memory module 120 may compress the write data having been transmitted at step S220. A compression ratio herein may be high or low according to a pattern of the write data.

The module controller 120 may write the compressed data having been compressed at step S230 to the memory devices 141 to 148, at step S240. Here, an area to be accessed in the memory devices 141 to 148 may be selected by the physical address mapped by the address mapping circuit 135.

The capacity measuring circuit 133 of the module controller 130 may generate unused memory capacity information UNUSED_INFO, and the unused memory capacity information UNUSED_INFO may be transmitted to the memory controller 110, at step S250. The unused memory capacity information UNUSED_INFO may be transmitted to the memory controller 110 through the data bus DATA_BUS or through a separate transmission line (not shown) for transmitting the unused memory capacity information UNUSED_INFO.

Although the memory module 120 can autonomously compresses the write data to write the compressed data to the memory devices 141 to 148, the memory controller 110 can determine a memory capacity available in the memory module 120 based on the unused memory capacity information UNUSED_INFO.

Accordingly, the memory controller 110 may use the entirety of capacity that becomes further available than an original memory capacity in the memory module 120 due to the data compression.

Step S250 may be performed whenever a write operation is completed. However, in a variation of this embodiment, step S250 may be periodically performed or may be performed in response to a request from the memory controller 110.

When step 250 is periodically performed, step S250 may be performed, for example, each time the write operation is performed 100 times or each time a constant time (e.g. 1000 clock cycles) passes.

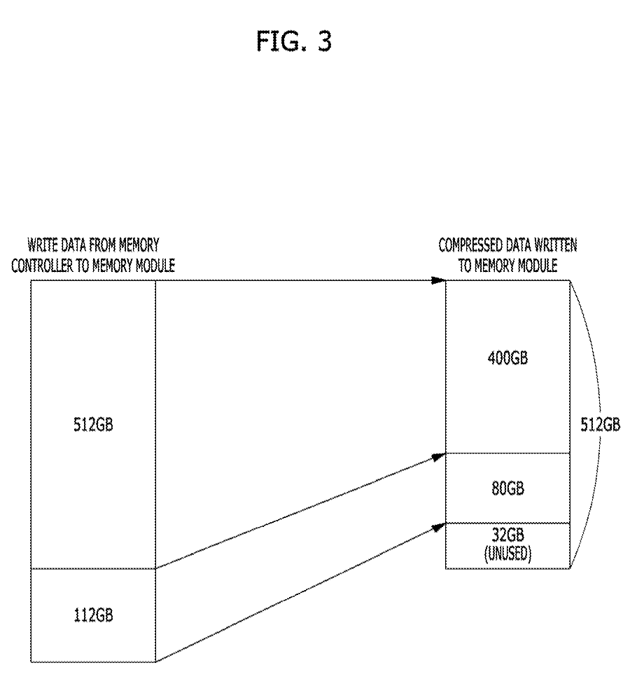

FIG. 3 is a diagram for explaining step S250 of FIG. 2 which is performed in response to a request from a memory controller 110. Here, it is assumed, as an example, that the entire capacity of the memory module 120 is 512 GB.

Referring to FIG. 3, the memory controller 110 may transmit up to 512 GB of write data to the memory module 120 without a request for the unused memory capacity information UNUSED_INFO.

After transmitting 512 GB of write data to the memory module 120, since the memory controller 110 does not know how much capacity is further available in the memory module 120, the memory controller 110 may request the unused memory capacity information UNUSED_INFO from the memory module 120. Here, the request may be transmitted from the memory controller 110 to the memory module 120 through the command bus CMD_BUS and the address bus ADD_BUS.

When the 512 GB of write data is compressed to 400 GB and the compressed data of 400 GB is written to the memory module 120, 112 GB of memory capacity remains unused. Therefore, the memory module 120 may transmit, to the memory controller 110, the unused capacity information UNUSED_INFO for indicating that the capacity of 112 GB is further available.

After transmitting additional 112 GB of write data of 2 GB to the memory module 120, the memory controller 110 may request the unused capacity information UNUSED_INFO from the memory module 120. Since the additional 112 GB write data is compressed to 80 GB before stored in the memory module 120, the memory module 120 may transmit the unused capacity information UNUSED_INFO indicating that 32 GB of memory capacity remains available to the memory controller 110.

When a method as the one described in FIG. 3 is employed, the memory controller 110 may use the entirety of capacity that becomes further available in the memory module 120 due to data compression, while the number of times when the unused capacity information UNUSED_INFO is transmitted between the memory controller 110 and the memory module 120 may be reduced to the minimum.

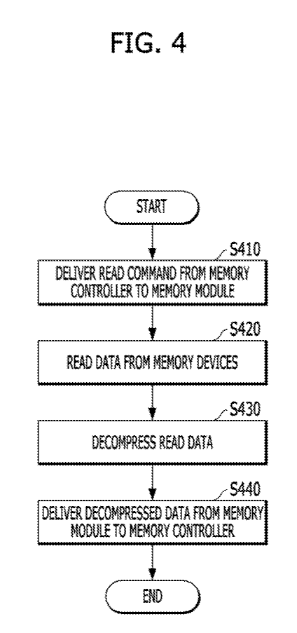

FIG. 4 is a flowchart illustrating a read operation of the memory system 100 of FIG. 1.

Referring to FIG. 4, a read command may be transmitted from the memory controller 110 to the memory module 120, at step S410. The read command may be transmitted through the command bus CMD_BUS. In addition together with the read command, the logical address may be transmitted from the memory controller 110 to the memory module 120 through the address bus ADD_BUS.

At step S420, the read data may be read from the memory devices 141 to 148 in the memory module 120 in response to the read command having been transmitted at step S410. Here, an area to be accessed in the memory devices 141 to 148 may be selected by the physical address mapped by the address mapping circuit 135 of the module controller 130.

The read data having been read at step S420 may be decompressed by the compress/decompress circuit 131 in the module controller 130, at step S430. In addition, the depressed data having been decompressed at step S430 may be transmitted to the memory controller 110, at step S440.

According to various embodiments of the present disclosure, an available memory capacity may be increased in a memory system.

Although various embodiments have been described for illustrative purposes, it will be apparent to those skilled in the art that various changes and modifications may be made without departing from the spirit and scope of the disclosure as defined in the following claims.

What is claimed is:

1. An operating method of a memory system, the operating method comprising:
transmitting a write command from a memory controller to a memory module;
transmitting write data corresponding to the write command from the memory controller to the memory module;
generating compressed data by compressing the write data in the memory module;
writing the compressed data to one or more memory devices in the memory module; and
transmitting unused memory capacity information on the memory module to the memory controller from the memory module.

2. The operating method of claim 1 wherein the transmitting of the unused memory capacity information is performed each time a write operation is completed.

3. The operating method of claim 1 wherein the transmitting of the unused memory capacity information is periodically performed.

4. The operating method of claim wherein the transmitting of the unused memory capacity information is performed in response to a request from the memory controller.

5. The operating method of claim 1, further comprising:
transmitting a read command from the memory controller to the memory module;
reading read data from the memory devices;
generating decompressed data by decompressing the read data in the memory module; and
transmitting the decompressed data from the memory module to the memory controller.

6. A memory module comprising:
one or more memory devices;
a compress/decompress circuit suitable for compressing write data to the memory devices and decompressing read data read from the memory devices; and
a capacity measuring circuit suitable for generating unused memory capacity information on the memory module,

7. The memory module of claim 6, wherein the memory module transmits the unused memory capacity information to a memory controller each time a write operation is completed.

8. The memory module of claim 6, wherein the memory module periodically transmits the unused memory capacity information to a memory controller.

9. The memory module of claim 6, wherein the memory module transmits the unused memory capacity information to a memory controller in response to a request from the memory controller.

10. The memory module of claim 6, further comprising:
an address mapping circuit suitable for mapping a logical address received from a memory controller to a physical address for selecting an area to be accessed in the memory devices.

11. A memory system comprising:
a memory module comprising one or more memory devices and a module controller suitable for controlling the memory devices; and
a memory controller suitable for instructing an operation of the memory module,
wherein the module controller comprises:
a compress/decompress circuit suitable for compressing write data to the memory devices and decompressing read data read from the memory devices; and
a capacity measuring circuit suitable for generating unused memory capacity information on the memory module.

12. The memory system of claim 11, wherein the memory module transmits the unused memory capacity information to the memory controller each time a write operation is completed.

13. The memory system of claim 11, wherein the memory module periodically transmits the unused memory capacity information to the memory controller.

14. The memory system of claim 11, wherein the memory module transmits the unused memory capacity information to the memory controller in response to a request from the memory controller.

15. The memory system of claim 11, herein the module controller further comprises:
an address mapping circuit suitable for mapping a logical address received from the memory controller to a physical address for selecting an area to be accessed in the memory devices.
